(19) United States
(12) Patent Application Publication
(10) Pub. No.: US 2004/0093777 A1
(43) Pub. Date: May 20, 2004

(54) Trigonal prism turning display device for advertisement

(76) Inventor: Sung Joon Park, In cheon (KR)

Correspondence Address: Mr. Eric Chan, 42 Pin Oaks Drive, Phoenixville, PA, 19460, US

(21) Appl. No.: 10/706,473

(22) Filed: Nov. 7, 2003

(30) Foreign Application Priority Data
Nov. 8, 2002 (KR) 10-2002-0069072

(51) Int. Cl. G09F 11/02

(52) U.S. Cl. 40/503

(57) ABSTRACT

Disclosed is a trigonal prism turning display device for advertisement including: six trigonal prisms arranged in a shape of a regular triangle, each of said six trigonal prisms having the three sides on each of which an advertising screen is displayed; upper and lower turning discs for supporting said six trigonal prisms and rotating together with a main shaft; driving means mounted under said lower turning disc, for rotating said six trigonal prisms; disc-type device supporting means mounted under said driving means and fixed to the inner surface of a cylindrical housing at the outer peripheral portion thereof, for supporting said main shaft and said driving means; and a motor disposed under said disc type device supporting means in such a manner as to be connected to the lower end of said main shaft by a coupler.

### BACKGROUND OF THE INVENTION

The present invention relates to a turning display device for advertisement, and more particularly, to a trigonal prism turning display device for advertisement where six hollow trigonal prisms are arranged in a shape of a regular triangle in such a manner that the respective sides of the six trigonal prisms form separate advertising screens, or as the six trigonal prisms are rotated, the three sides by three trigonal prisms are combined to display three advertising screens, and where as each of the six trigonal prisms is rotated, at least 18 kinds of advertising screens can be displayed, thereby improving a advertising efficiency relative to the area occupied by the device, and corresponding advertising things are put for their display in the interior of each of the trigonal prisms, thereby increasing a space utility.

In general, display devices for advertisement using a trigonal prism are embodied by printing or attaching different kinds of advertisements on the respective sides of the trigonal prism and then by turning the trigonal prism, thereby accomplishing the three kinds of advertisements at a time, which is also called “TriVision”. However, the conventional trigonal prism turning display devices for advertisement have a limitation in that just one kind of advertising screen is displayed on each of the three sides of the trigonal prism.

Another advertising display device that has been provided to overcome the aforementioned defect is disclosed in Korean Utility Model Registration No. 20-0279171, where a plurality of trigonal prisms that are arranged in a line are turned such that the images on the respective sides of the plurality of trigonal prisms are combined to thereby display its designed advertisements. As shown in FIGS. 1 to 3, a turning member 2 that is vertically installed is intermittently rotated as a turning shaft 1 that is horizontally installed is rotated, and a plurality of trigonal prisms 3 are rotatably mounted in the inside of the outer frame of the device, such that different kinds of advertisements can be displayed by the combination of the respective sides of the plurality of trigonal prisms. The display device is provided with triangular turning plates 5 and 5′ each having the turning member 2 rotated by the twisted hexagonal turning shaft 1 and trigonal prism insertion parts 4 and 4′ and with a bearing bracket 6, wherein when a guide protrusion 7 of the turning member 2 is rotated at a distance within a predetermined angle (i.e., 120°) while the turning member 2 being rotated at an angle of 360° in a manner of a bevel gear, it is inserted into a guide groove 9 that is formed on a protrusion part 8 of each of the turning plates 5 and 5′, such that the turning plates 5 and 5′ are rotated until the turning protrusion 8 is deviated from the distance within the predetermined angle (120°), thereby making another side that is behind the displayed side of each of the trigonal prisms displayed on the front of the device. This results in the display of the different kinds of advertisements on the front of the device.

Since the aforementioned conventional display device using the plurality of trigonal prisms is embodied only in one direction, however, the number of people who can see the advertisement is restricted. That is to say, only the people who are in front of the advertising screen as shown in FIG. 3 can watch it, but those who are in the left and right sides of the advertising screen or behind it cannot watch it. In addition, each of the plurality of trigonal prisms has a substantially narrow width, and a number of such the trigonal prisms are combined to display the designed advertising screen, such that the advertising screen has a relatively low degree of resolution. As noted above, the widths of the three sides of each of the trigonal prisms are too small to keep and display a product sample to be advertised in the interior thereof.

### BRIEF SUMMARY OF THE INVENTION

Accordingly, the present invention has been made in view of the above problems due to limitations and disadvantages of the conventional prior art device, and an object of the present invention is to provide a trigonal prism turning display device for advertisement that can be rotated in every direction at an angle of 360° relative to the device.

Another object of the present invention is to provide a trigonal prism turning display device for advertisement that can make a plurality of trigonal prisms rotated in a simple manner thereby displaying a number of different kinds of advertising screens.

Still another object of the present invention is to provide a trigonal prism turning display device for advertisement that is convenient to use in various places such as shopping malls, department stores, airports, stations, show windows, bars, cafes, fitness clubs, sports stadium, and so on.

Yet another object of the present invention is to provide a trigonal prism turning display device for advertisement that allows product samples be exhibited in the interiors of the trigonal prisms, thereby maximizing a space utility of the advertising device.

A further object of the present invention is to provide a trigonal prism turning display device for advertisement that can be provided with the three sides of each of the trigonal prisms that are made with a Panapress advertising plate to have lighting equipment in the interiors thereof, thereby achieving a substantially high advertising efficiency with the help of a high degree of resolution.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to the above objects of the present invention, as embodied and broadly described herein, there is provided a trigonal prism turning display device for advertisement including: six trigonal prisms arranged in a shape of a regular triangle, each of said six trigonal prisms having the three sides on each of which an advertising screen is displayed; upper and lower turning discs for supporting said six trigonal prisms and rotating together with a main shaft; driving means mounted under said lower turning disc, for rotating said six trigonal prisms; disc-type device supporting means mounted under said driving means and fixed to the inner surface of a cylindrical housing at the outer peripheral portion thereof, for supporting said main shaft and said driving means; and a motor disposed under said disc type device supporting means in such a manner as to be connected to the lower end of said main shaft by a coupler.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a conventional trigonal prism turning display device for advertisement;

FIG. 2 is a perspective view showing the turning structure for the trigonal prism turning display device for advertisement in FIG. 1, which is in use;

FIG. 3 is an exemplary view showing the use method for the trigonal prism turning display device for advertisement in FIG. 1;

FIG. 4 is a perspective view showing the configuration of the main parts of a trigonal prism turning display device for advertisement according to the present invention;

FIG. 5 is a perspective view showing the driving part in the trigonal prism turning display device for advertisement according to the present invention;

FIG. 6 is a sectional view showing the configuration of the main parts of the trigonal prism turning display device for advertisement according to the present invention;

FIG. 7 is a perspective view showing the trigonal prism for the display device of the present invention;

FIGS. 8a to 8d are views showing the turning process of the trigonal prisms according to forward rotation of a partial gear 27;

FIGS. 9a to 9d are views showing the turning process of the trigonal prisms according to backward rotation of a partial gear 27′;

FIGS. 10a to 10d are views showing the turning process of the trigonal prisms according to backward rotation of the partial gear 27;

FIGS. 11a to 11d are views showing the turning process of the trigonal prisms according to forward rotation of the partial gear 27′;

FIGS. 12a and 12b are views showing the turning process of the trigonal prisms in accordance with their turning directions and angles;

FIGS. 13a and 13b are views showing the turning process of the trigonal prisms in accordance with their turning directions and angles; and

FIG. 14 is a view showing the advertising screens where the three sides of the three trigonal prisms are combined by cycles.

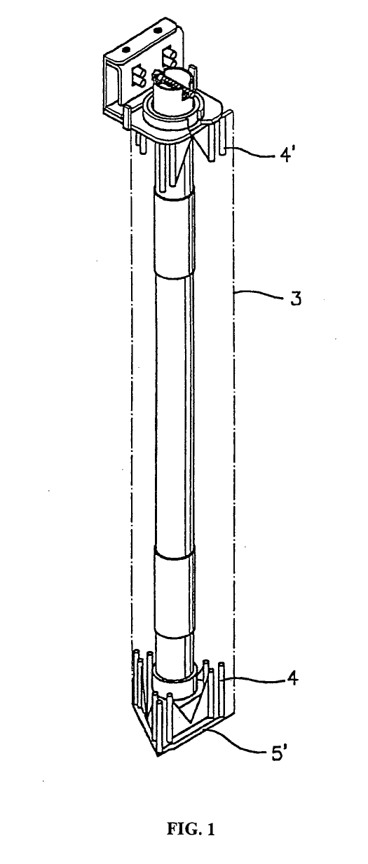

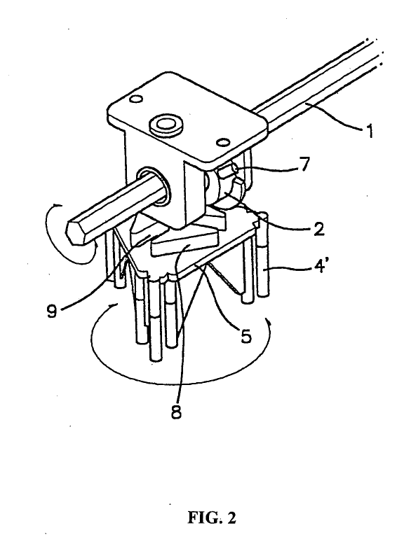

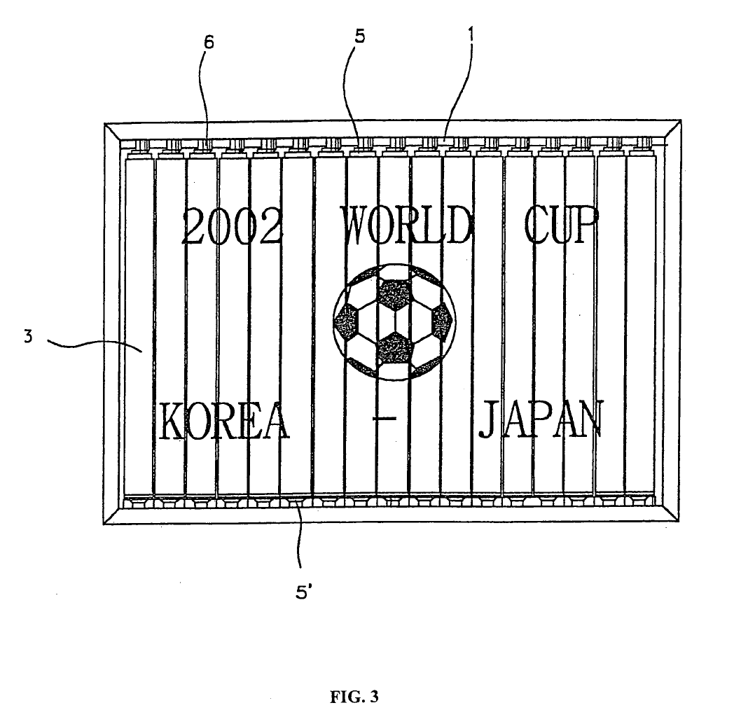

### DETAILED DESCRIPTION OF THE INVENTION

Reference will now be made in detail to the preferred embodiments of the present invention, examples of which are illustrated in the accompanying drawings.

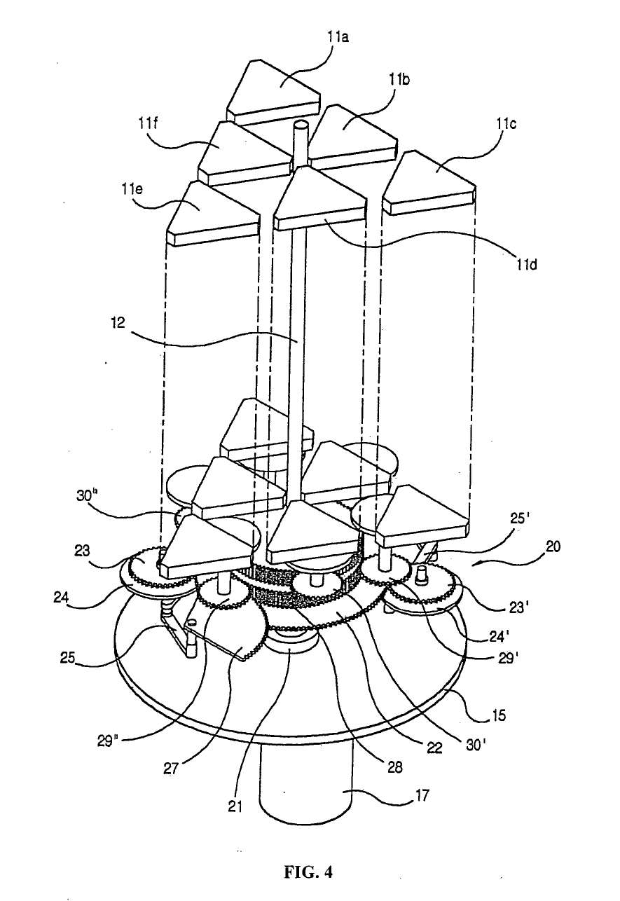

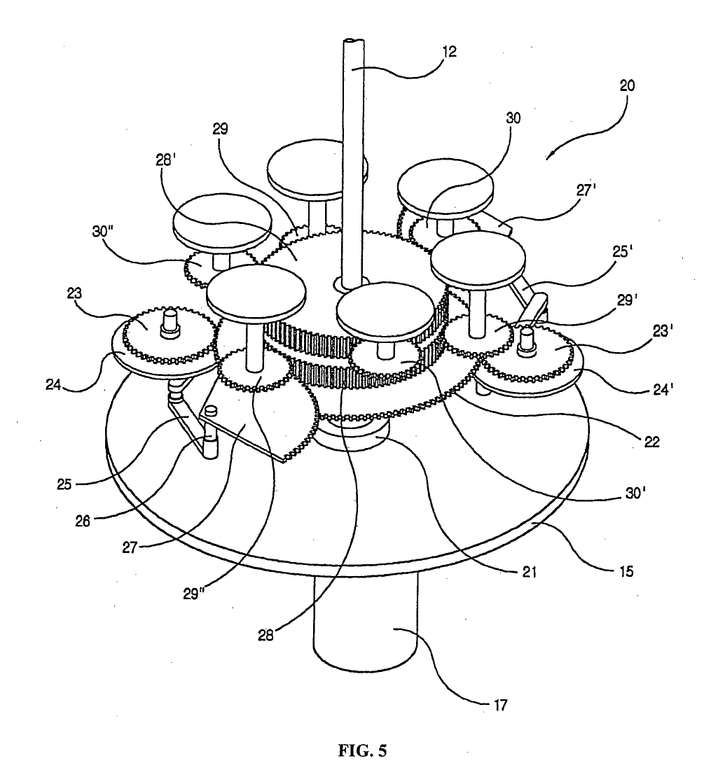

FIG. 4 is a perspective view showing the configuration of the main parts of a trigonal prism turning display device for advertisement according to the present invention, FIG. 5 is a perspective view showing the driving part in the trigonal prism turning display device of this invention, FIG. 6 is a sectional view showing the configuration of the main parts of the trigonal prism turning display device of this invention, and FIG. 7 is a perspective view showing the trigonal prism in the display device of the present invention. As shown in FIG. 7, each of the six trigonal prisms 11a to 11f is made of glass, acryl, or aluminum, such that it has a hollow part 18 in the interior thereof and it has an advertising screen on the three sides thereof or a product display stand 19 in one side among the three sides thereof, wherein the advertising screen is attached on the respective sides of the trigonal prisms 11a to 11f with a sheet of paper or through the printing with a photograph taken from the life or each of the trigonal prisms is configured in such a manner that the three sides are formed with the insertion of an acryl plate having the advertising screen. Also, each of the trigonal prisms has Panapress advertising plates on the three sides and thus includes lighting equipment in the hollow part 18, such that the advertising screens on the three sides are substantially vivid, especially at night, without any additional lighting device.

As shown in FIGS. 4 to 6, the main shaft 12 is coupled to the shaft of the motor 17 through the coupler 16, at the lower end thereof, and the central portion of the lower turning disc 13′ is secured on the central portion of the main shaft 12, and the central portion of the upper turning disc 13 on the upper end thereof, with a result that the upper and lower turning discs 13 and 13′ are rotated together with the main shaft 12 that delivers the rotating force of the motor 17 to the driving part 20.

The cylindrical housing 14 is made of a transparent acryl and has a fixing member 16′ that is adapted to fix the main shaft 12 in the central portion of the upper surface thereof. The cylindrical housing 14 has the six trigonal prisms I a to 1 If in the upper portion thereof, the driving part 20 in the central portion thereof, and the motor 17 in the lower portion thereof.

The driving part 20 includes: a base gear 22 that is coupled to the main shaft 12 through a bolt 21 that is fixedly installed on the central portion of the device supporting part 15; a pair of crankshaft gears 23 and 23′ engaged with the base gear 22 at intervals of 180° in a rotating direction of the base gear 22; a pair of connecting rods 25 and 25′ that are fixedly mounted at the margins of crank connecting discs 24 and 24′ that are secured on the lower surfaces of the crankshaft gears 23 and 23′; a pair of crankshafts 26 and 26′ that are connected to the frontal ends of the connecting rods 25 and 25′; a pair of partial gears 27 and 27′ that are fixed on the crankshafts 26 and 26′ at the rotating central portions thereof; trigonal prism power transmission gears 28 and 28′ that are engaged with the partial gears 27 and 27′ at the lower portion thereof so as to be rotated as the partial gears 27 and 27′ are rotated; first trigonal prism turning gears 29, 29′ and 29″ that are engaged at intervals of 120° with the trigonal prism power transmission gear 28, such that the three trigonal prisms 11a, 11c and lie are rotated; and second trigonal prism turning gears 30, 30′ and 30″ that are engaged at intervals of 120° with the trigonal prism power transmission gear 28′, such that the three trigonal prisms 11b, 11d and 11f are rotated.

Each of the trigonal prism turning gears 29, 29′ and 29″ is fixed with a disc-shaped connecting member at the top end of the shaft thereof, and each of the disc-shaped connecting members is secured on the bottom surface of the one side of each of the trigonal prisms 11a, 11c and 11e at the central upper surface thereof, such that the trigonal prisms 11a, 11c and lie are rotated as the trigonal prism turning gears 29, 29′ and 29″ are rotated. Also, each of the trigonal prism turning gears 30, 30′ and 30″ is fixed with a disc-shaped connecting member at the top end of the shaft there, and each of the disc-shaped connecting members is secured on the bottom surface of the one side of each of the trigonal prisms 11b, 11d and 11f at the central upper surface thereof, such that the trigonal prisms 11b, 11d and 11f are rotated as the trigonal prism turning gears 30, 30′ and 30″ are rotated.

In this case, the partial gears 27 and 27′ are toothed gears having the angle of 120° and are fixed on the crankshafts 26 and 26′ on the rotating central portions thereof. As the crankshafts 26 and 26′ are rotated, the partial gears 27 and 27′ are rotated within the angle of 60° except the tooth within the both outside sections at the angle of 30°, which allows the trigonal prism power transmission gears 28 and 28′ to be rotated at an angle of 60°.

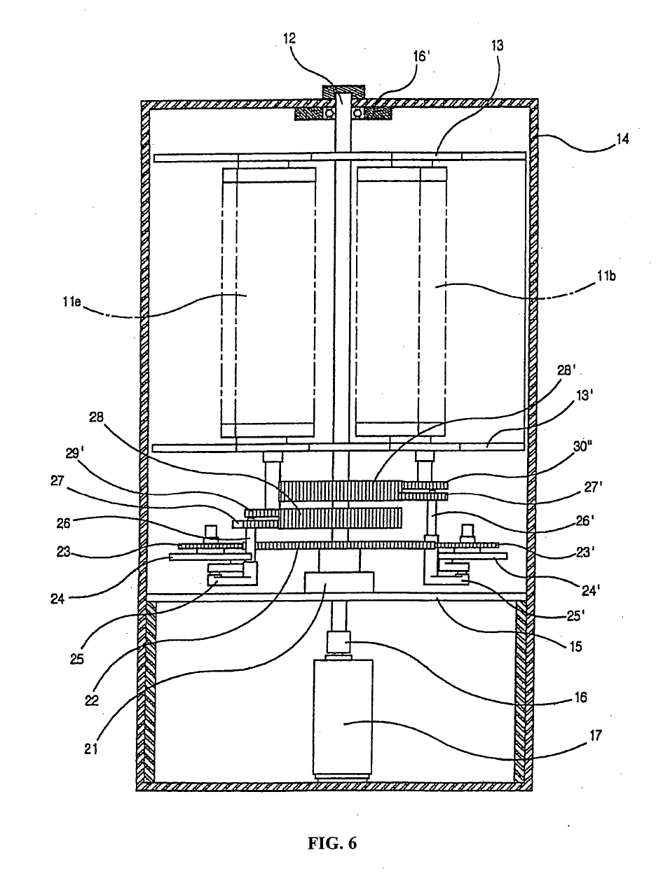

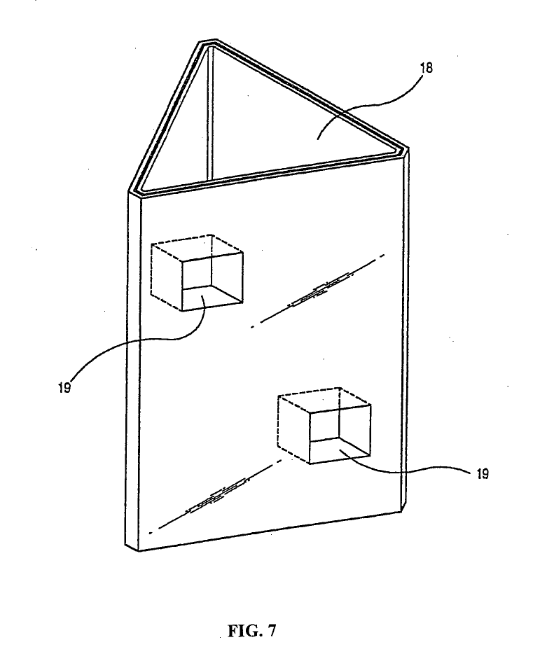

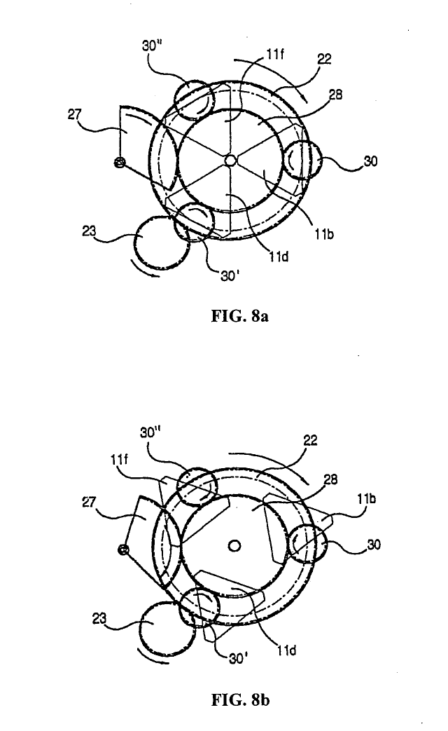

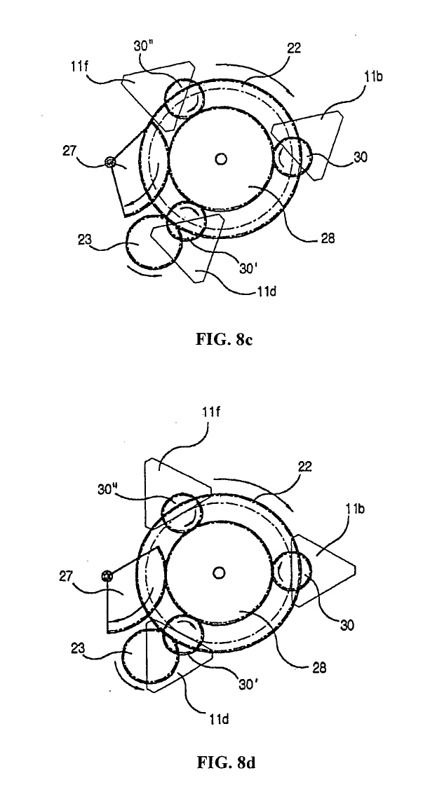

Based upon the configuration of the driving part 20, an explanation of the rotating operation of the trigonal prisms 11a to 11f will be given with reference to FIGS. 8a to 14.

For the convenience of explanation, FIGS. 8a to 11d show the movements of the crankshaft gears 23 and 23′, the partial gears 27 and 27′, and the trigonal prism power transmission gears 28 and 28′ in accordance with the arrangements of the trigonal prisms 11a to 11f. In this figures, the trigonal prism turning gears 29, 29′, 29″, 30, 30′ and 30″ which are connected at the intervals of 120° on the trigonal prism power transmission gears 28 and 28′ to thereby make the trigonal prisms 11a to 11f rotate, are shown in one plane.

The connecting rods 25 and 25′ that are not shown in FIGS. 8a to 11d are connected with the margins of the crank connecting members 24 and 24′ fixed on the crankshaft gears 23 and 23′, at one side ends thereof and connected with the crankshafts 26 and 26′, at the other side ends thereof. The crankshafts 26 and 26′ are secured on the rotating central portions of the partial gears 27 and 27′, such that as the crankshaft gears 23 and 23′ are rotated, the partial gears 27 and 27′ are rotated repeatedly in forward and backward directions within its rotating section of 60° in the unit of cycle. At that time, the partial gear 27 is always rotated in the opposite direction to the partial gear 27′.

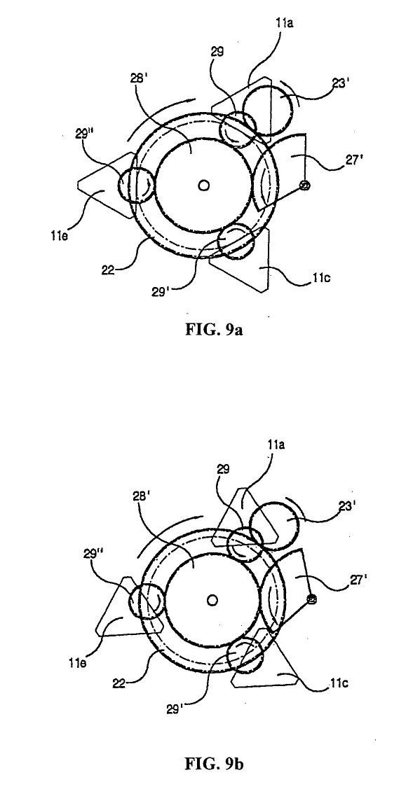

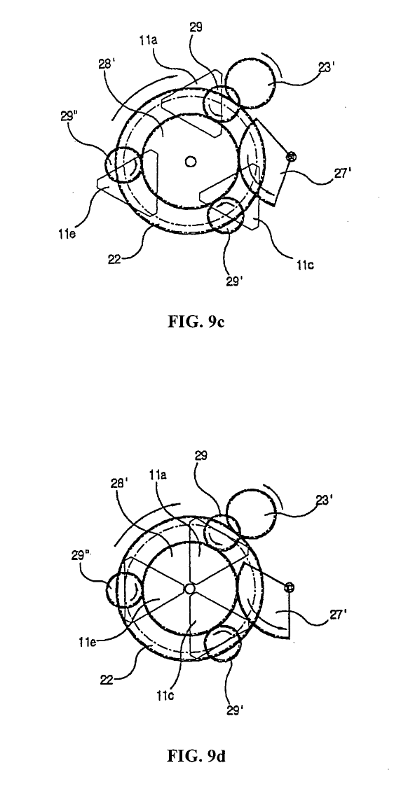

When the motor 17 operates to rotate the main shaft 12 in a clockwise direction (hereinafter, referred to as ‘forward’), the base gear 22 that is fixed on the main shaft 12 is rotated forward together with the main shaft 12, as shown in FIGS. 8a to 9d.

The crankshaft gears 23 and 23′ that are connected with the base gear 22 are rotated in a counterclockwise direction (hereinafter, referred to as ‘backward’), and thereby, the partial gear 27 is rotated forward and the partial gear 27′ is rotated backward by the operations of the connecting rods 25 and 25′.

Thus, the trigonal prism power transmission gear 28 is rotated backward and the trigonal prism power transmission gear 28 is rotated forward, such that the trigonal prism turning gears 29, 29′ and 29″ are rotated backward and the trigonal prism turning gears 30, 30′ and 30″ are rotated forward. So, the trigonal prisms 11a, 11c and 11e connected on the shafts of the trigonal prism turning gears 29, 29′ and 29″ are rotated backward, and the trigonal prisms 11b, 11d and 11f connected on the shafts of the trigonal prism turning gears 30, 30′ and 30″ are rotated forward.

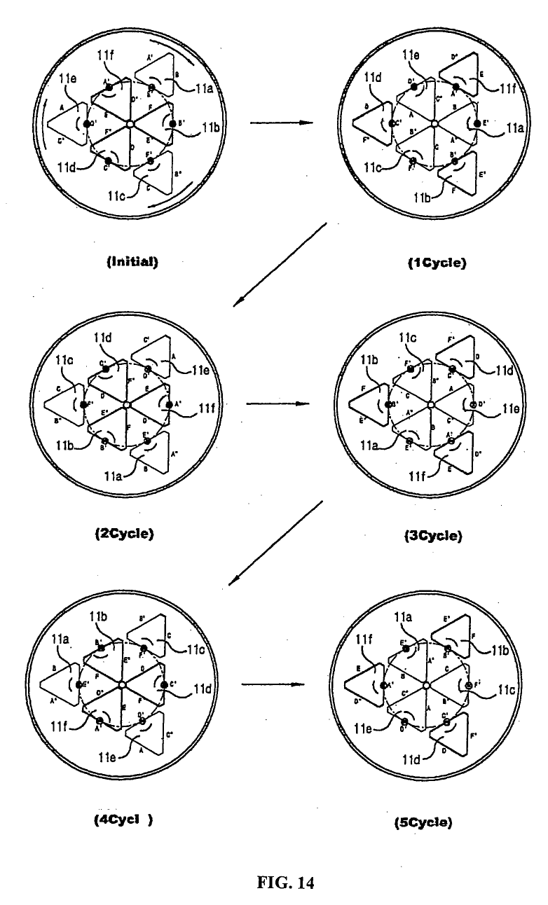

An initial operation starts at the states in FIGS. 8a and 9a, that is, at the initial state of FIG. 14 (wherein, the side B of the trigonal prism 11a, the side B′ of the trigonal prism 11b, and the side B″ of the trigonal prism 11c are combined to be exposed to outside, thus to display an advertising screen (the sides BB′B″), the sides of the trigonal prisms 11c, 11d, and 11e are combined thus to display another advertising screen (the sides CC′C″), and the sides of the trigonal prisms 11e, 11f, and 11a are combined thus to display yet another advertising screen (the sides AA′A″)), and as the partial gear 27 is rotated forward and the partial gear 27′ is rotated backward, the trigonal prism power transmission gears 28 and 28′ that are connected with the partial gears 27 and 27′ are rotated forward and backward. Thus, the trigonal prism turning gears 29, 29′ and 29″ are rotated backward, and the trigonal prism turning gears 30, 30′ and 30″ are rotated forward.

By the way, the partial gears 27 and 27′ and the trigonal prism power transmission gears 28 and 28′ have the same gear ratio, and the trigonal prism power transmission gears 28 and 28′ and the trigonal prism turning gears 29, 29′, 29″, 30, 30′ and 30″ have the gear ratio of 3:1. Thus, when the partial gears 27 and 27′ are rotated forward and backward by 10°, the trigonal prisms 11a, 11c, and 11e are rotated backward by 30° together with the trigonal prism turning gears 29, 29′, and 29″, and the trigonal prisms 11b, 11d, and 11f are rotated forward by 30° together with the trigonal prism turning gears 30, 30′, and 30″. As shown in FIG. 12a, each of the trigonal prisms 11a to 11f becomes rotated by 30°.

FIGS. 8b and 9b show the states where the partial gears 27 and 27′ are rotated forward and backward by 20° (which means each of the trigonal prisms 11a to 11f becomes rotated by 60° in FIG. 12a), FIGS. 8c and 9c show the states where the partial gears 27 and 27′ are rotated forward and backward by 40° (which means each of the trigonal prisms 11a to 11f becomes rotated by 120° in FIG. 12b), and FIGS. 8d and 9d show the states where the partial gears 27 and 27′ are rotated forward and backward by 60° (which means each of the trigonal prisms 11a to 11f becomes rotated by 180° in FIG. 12b).

As the partial gears 27 and 27′ are rotated forward and backward by 60°, each of the trigonal prisms 11a to 11f is rotated forward and backward by 180°. So, the trigonal prisms 11a, 11c, and 11e are rotated backward by 180° together with the trigonal prism turning gears 29, 29′ and 29″, and the trigonal prisms 11b, 11d, and 11f are rotated forward by 180° together with the trigonal prism turning gears 30, 30′ and 30″, where each of the trigonal prisms 11a to 11f becomes rotated by 180° in FIG. 12b.

The rotating operations of the trigonal prisms 11a to 11f are carried out until the main shaft 12 is rotated by 60°, that is, until the crankshaft gears 23 and 23′ are rotated by 180°. This is allowed because the upper and lower turning discs 13 and 13′ and the base gear 22 are secured on the main shaft 12, the crankshaft gears 23 and 23′ are in mesh with the base gear 22, and the base gear 22 and the crankshaft gears 23 and 23′ have the gear ratio of 3:1.

Since the main shaft 12 is rotated by 60° at the state where the trigonal prisms 11a to 11f are rotated by 180° (which means each of the trigonal prisms 11a to 11f becomes rotated by 180° in FIG. 12b), therefore, the whole trigonal prism is rotated by 60° and moved by one cycle (in FIG. 14), such that the trigonal prism 11a moves to the position of the trigonal prism 11b, the trigonal prism 11b to the position of the trigonal prism 11c, the trigonal prism 11c to the position of the trigonal prism 11d, the trigonal prism 11d to the position of the trigonal prism 11e, the trigonal prism 11e to the position of the trigonal prism 11f, and the trigonal prism 11f to the position of the trigonal prism 11a.

Thus, the side A″ of the trigonal prism 11a is replaced with the side D″ of the trigonal prism 11f, the side A′ of the trigonal prism 11f with the side D′ of the trigonal prism 11e, the side A of the trigonal prism 11e with the side D of the trigonal prism 11d, the side C″ of the trigonal prism 11e with the side F″ of the trigonal prism 11d, the side C′ of the trigonal prism 11d with the side F′ of the trigonal prism 11c, the side C of the trigonal prism 11c with the side F of the trigonal prism 11b, the side B″ of the trigonal prism 11c with the side E″ of the trigonal prism 11b, the side B′ of the trigonal prism 11b with the side E′ of the trigonal prism 11a, and the side B of the trigonal prism 11a with the side E of the trigonal prism 11f.

The sides BB′B″, CC′C″ and AA′A″ at the initial state of the combination of the trigonal prisms 11a to 11f in FIG. 14 are moved to the sides EE′E″, FF′F″ and DD′D″ at the state of being moved by one cycle in FIG. 14.

At the state where the whole trigonal prism has been moved by one cycle, when the motor 17 operates to rotate the main shaft 12, the base gear 22 that is secured on the main shaft 12 is rotated forward together with the main shaft 12.

As a result, the crankshaft gears 23 and 23′ that are connected with the base gear 22 are rotated backward, so that as the connecting rods 25 and 25′ start to operate, the partial gear 27 is rotated backward and the partial gear 27′ is rotated forward.

Then, the trigonal prism power transmission gear 28 is rotated forward and the trigonal prism power transmission gear 28′ is rotated backward, such that the trigonal prism turning gears 29, 29′ and 29″ are rotated forward and the trigonal prism turning gears 30, 30′ and 30″ are rotated backward. Thereby, the trigonal prisms 11a, 11c and 11e that are connected to the shafts of the trigonal prism turning gears 29, 29′ and 29″ are rotated forward, and the trigonal prisms 11b, 11d and 11f that are connected to the shafts of the trigonal prism turning gears 30, 30′ and 30″ are rotated backward.

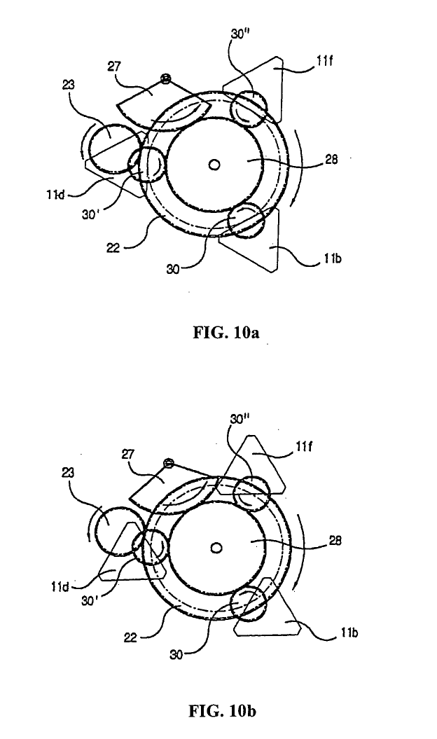

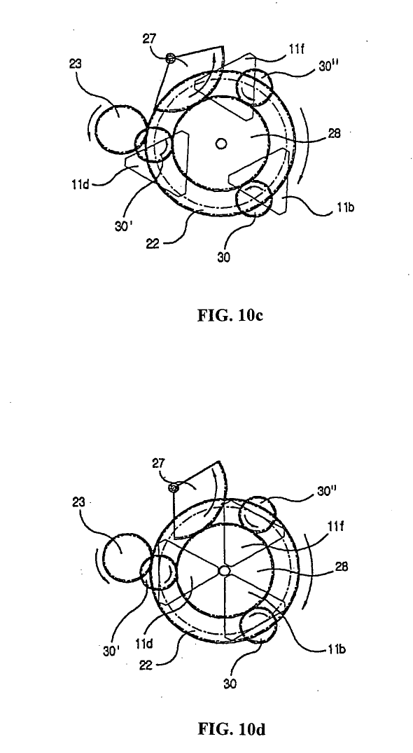

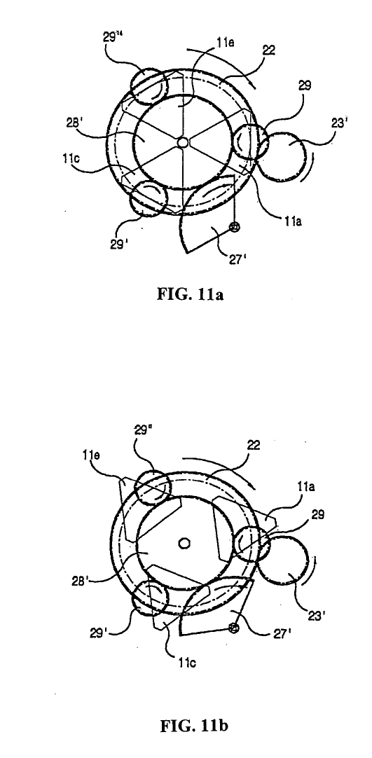

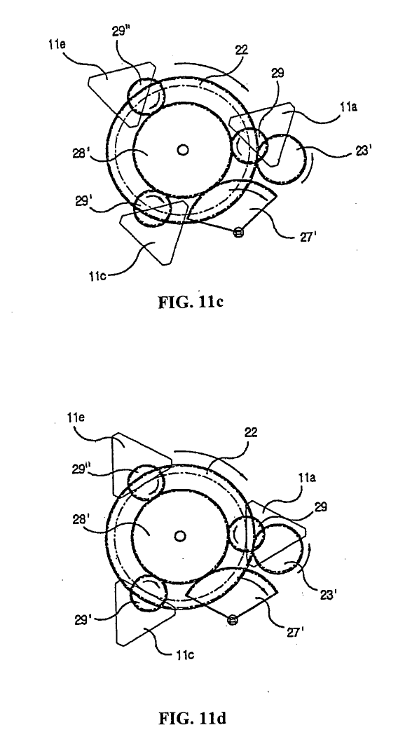

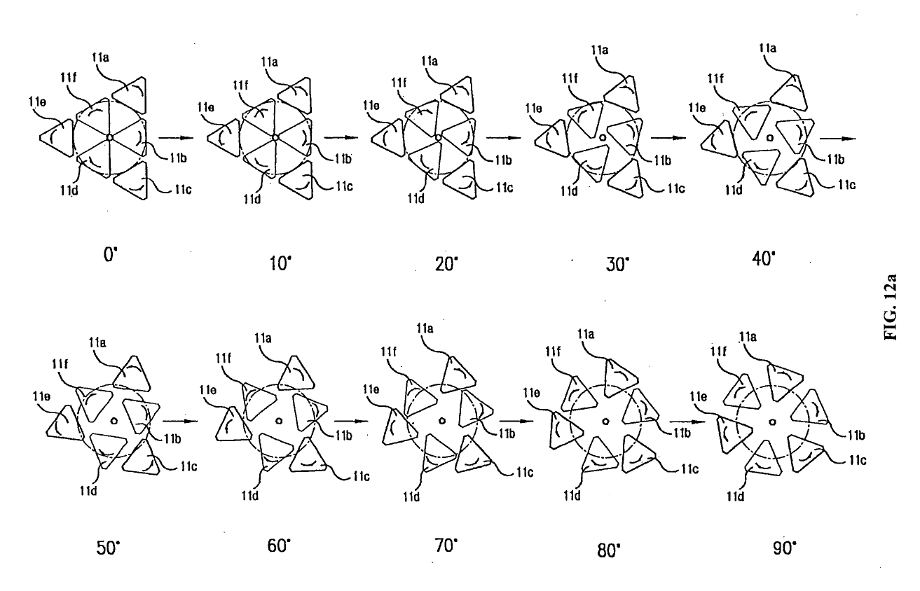

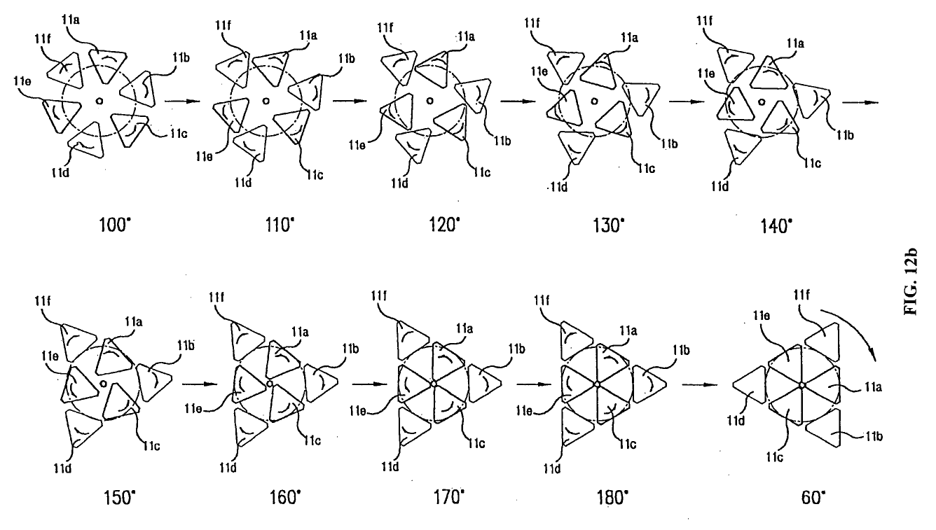

Therefore, the operation starts at the states in FIGS. 10a and 11a, that is, at the state of the one cycle in FIG. 14 (wherein, the side E of the trigonal prism 11f, the side E′ of the trigonal prism 11a, and the side E″ of the trigonal prism 11b are combined to be exposed to outside, thus to display an advertising screen (the sides EE′E″), the sides of the trigonal prisms 11b, 11c, and 11d are combined thus to display another advertising screen (the sides FF′F″), and the sides of the trigonal prisms 11d, 11e, and 11f are combined thus to display yet another advertising screen (the sides DD′D″)), and as the partial gear 27 is rotated backward and the partial gear 27′ is rotated forward, the trigonal prism power transmission gears 28 and 28′ that are connected with the partial gears 27 and 27′ are rotated forward and backward. Thus, the trigonal prism turning gears 29, 29′ and 29″ are rotated forward, and the trigonal prism turning gears 30, 30′ and 30″ are rotated backward.

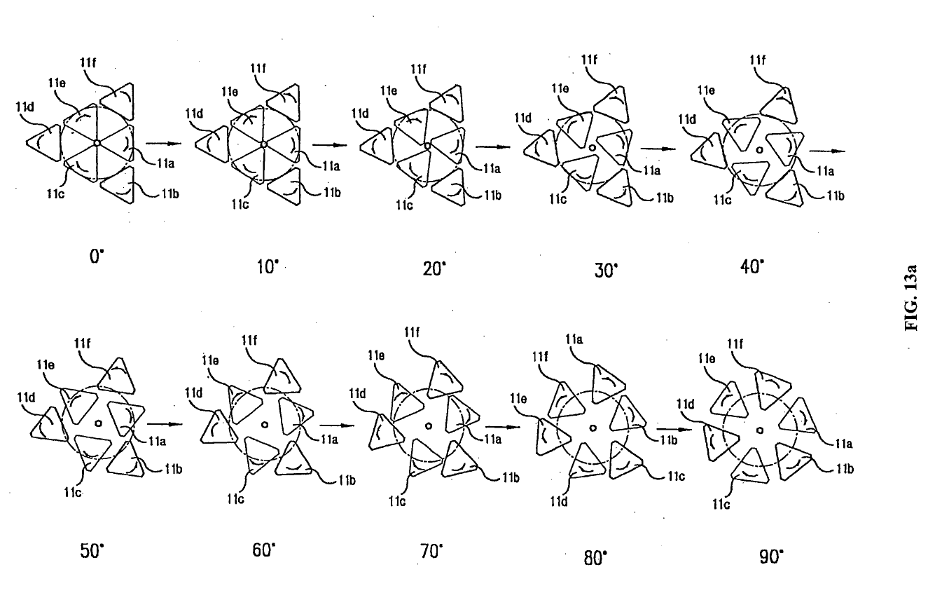

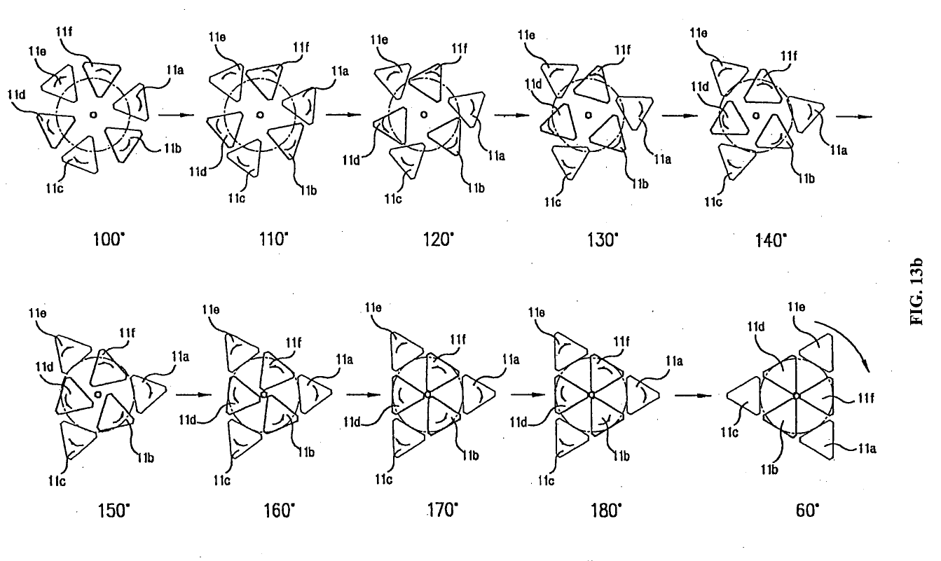

By the way, the partial gears 27 and 27′ and the trigonal prism power transmission gears 28 and 28′ have the same gear ratio, and the trigonal prism power transmission gears 28 and 28′ and the trigonal prism turning gears 29, 29′, 29″, 30, 30′ and 30″ have the gear ratio of 3:1. Thus, when the partial gears 27 and 27′ are rotated backward and forward by 10°, the trigonal prisms 11a, 11c, and 11e are rotated forward by 30° together with the trigonal prism turning gears 29, 29′ and 29″, and the trigonal prisms 11b, 11d, and 11f are rotated backward by 30° together with the trigonal prism turning gears 30, 30′ and 30″. As shown in FIG. 13a, each of the trigonal prisms 11a to 11f becomes rotated by 30°.

FIGS. 10b and 11b show the states where the partial gears 27 and 27′ are rotated backward and forward by 20° (which means each of the trigonal prisms 11a to 11f becomes rotated by 60° in FIG. 13a), FIGS. 10c and 11c show the states where the partial gears 27 and 27′ are rotated backward and forward by 40° (which means each of the trigonal prisms 11a to 11f becomes rotated by 120° in FIG. 13b), and FIGS. 10d and 11d show the states where the partial gears 27 and 27′ are rotated backward and forward by 60° (which means each of the trigonal prisms 11a to 11f becomes rotated by 180° in FIG. 13b).

The angles that are shown in FIGS. 13a and 13b represent the rotating angles of the trigonal prisms (wherein the trigonal prisms 11b, 11d and 11f are denoted with backward angles and the trigonal prisms 11a, 11c and 11e with forward angles).

As the partial gears 27 and 27′ are rotated backward and forward by 60°, each of the trigonal prisms 11a to 11f is rotated forward and backward by 180°. So, the trigonal prisms 11a, 11c, and 11e are rotated forward by 180° together with the trigonal prism turning gears 29, 29′ and 29″, and the trigonal prisms 11b, 11d, and 11f are rotated backward by 180° together with the trigonal prism turning gears 30, 30′ and 30″, where each of the trigonal prisms 11a to 11f becomes rotated by 180° in FIG. 13b.

The rotating operations of the trigonal prisms 11a to 11f are carried out until the main shaft 12 is rotated forward by 60° at the state of the one cycle in FIG. 14, that is, until the crankshaft gears 23 and 23′ are rotated backward by 180°. This is allowed because the upper and lower turning discs 13 and 13′ and the base gear 22 are secured on the main shaft 12, the crankshaft gears 23 and 23′ are connected with the base gear 22, and the base gear 22 and the crankshaft gears 23 and 23′ have the gear ratio of 3:1.

Since the main shaft 12 is rotated by 60° at the state where the trigonal prisms 11a to 11f are rotated by 180° (which means each of the trigonal prisms 11a to 11f becomes rotated by 180° in FIG. 13b), therefore, the whole trigonal prism is rotated by 60° and moved by one cycle (at the state of two cycles in FIG. 14), such that the trigonal prism 11a moves to the position of the trigonal prism 11b, the trigonal prism 11b to the position of the trigonal prism 11c, the trigonal prism 11c to the position of the trigonal prism 11d, the trigonal prism 11d to the position of the trigonal prism 11e, the trigonal prism 11e to the position of the trigonal prism 11f, and the trigonal prism 11f to the position of the trigonal prism 11a.

Thus, the side D″ of the trigonal prism 11f is replaced with the side C″ of the trigonal prism 11e, the side D′ of the trigonal prism 11e with the side C′ of the trigonal prism 11d, the side D of the trigonal prism 11d with the side C of the trigonal prism 11c, the side F″ of the trigonal prism 11d with the side B″ of the trigonal prism 11c, the side F′ of the trigonal prism 11c with the side B′ of the trigonal prism 11b, the side F of the trigonal prism 11b with the side B of the trigonal prism 11a, the side E″ of the trigonal prism 11b with the side A″ of the trigonal prism 11a, the side E′ of the trigonal prism 11a with the side A′ of the trigonal prism 11f, and the side E of the trigonal prism 11f with the side A of the trigonal prism 11e.

The sides EE′E″, FF′F″ and DD′D″ at the state of the one cycle by the combination of the trigonal prisms 11a to 11f in FIG. 14 are moved to the sides AA′A″, BB′B″ and CC′C″ at the state of being moved by two cycles in FIG. 14.

That is, as the same operations as mentioned above are carried out, the six trigonal prisms 11a to 11f are rotated by 180° at a period of one cycle, which makes the whole trigonal prism rotated forward by 60° with the results of FIG. 14. Thus, the three sides that are combined in the six trigonal prisms 11a to 11f according to the movements of the cycles as shown in FIG. 14 are as follows:

| | |
|---|---|
| BB′B″-CC′C″-AA′A″: | at the initial state |
| ↓ ↓ ↓ | |
| EE′E″-FF′F″-DD′D″: | at the state of one cycle |
| ↓ ↓ ↓ | |
| AA′A″-BB′B″-CC′C″: | at the state of two cycles |
| ↓ ↓ ↓ | |
| DD′D″-EE′E″-FF′F″: | at the state of three cycles |
| ↓ ↓ ↓ | |
| CC′C″-AA′A″-BB′B″: | at the state of four cycles |
| ↓ ↓ ↓ | |
| FF′F″-DD′D″-EE′E″: | at the state of five cycles |
| ↓ ↓ ↓ | |
| BB′B″-CC′C″-AA′A″: | at the initial state |

According to the preferred embodiment of the present invention, the motor 17 is driven to rotate the main shaft 12 and the base gear 22 and thereby, the crankshaft gears 23 and 23′ that are connected with the base gear 22 are rotated, so that as the connecting rods 25 and 25′ start to operate, the partial gears 27 and 27′ are repeatedly rotated forward and backward at periods of the rotating angle 60°. As the partial gears 27 and 27′ are rotated, the trigonal prism power transmission gears 28 and 28′ are repeatedly rotated forward and backward at periods of the rotating angle 60°, such that the trigonal prisms on the sides of the regular triangle and those on the three vertexes are rotated by 180° for one cycle in an opposite direction to one another, without any collision. At the same time, the whole trigonal prism is rotated by 60° for one cycle together with the turning discs 13 and 13′ as the main shaft 12 is rotated, such that the three sides of each of the six trigonal prisms are combined to thereby display three advertising screens. Therefore, as the turning discs 13 and 13′ are rotated by 360° together with the main shaft 12, six kinds of advertising screens are displayed in turn on the sides of the six trigonal prisms.

While there has been described above the rotational movement of the trigonal prisms using the motor and the different kinds of gears as the driving sources with reference to the preferred embodiment of the present invention, such description is for illustrative purpose only, and is it to be understood that various variations and modifications thereto may be made without departing from the spirit or scope of the following claims.

For example, a step motor is mounted on the trigonal prisms, respectively and is driven by a microprocessor to rotate them with the differences in time, such that the six trigonal prisms are rotated without any collision with one another and also the whole trigonal prism is rotated to thereby change the advertising screens on the combined three sides of each trigonal prisms.

As clearly mentioned above, the trigonal prism turning display device for advertisement according to the present invention is embodied by arranging the six trigonal prisms in a shape of a regular triangle in such a manner that the trigonal prisms on the sides of the regular triangle and those on the three vertexes are rotated by 180° for one cycle in an opposite direction to one another, without any collision, and at the same time, in such a manner that the whole trigonal prism is rotated by 60° for one cycle together with the turning discs 13 and 13′ as the main shaft 12 is rotated, such that the three sides of each of the six trigonal prisms are combined to thereby display the advertising screen for one side of the whole trigonal prism. Therefore, the advertisements comprised of the advertising screens on the respective sides of the trigonal prisms can be seen in every direction as the device of this invention is rotated by 360°.

The trigonal prism turning display device for advertisement of this invention can display the six kinds of advertisements, such that they are displayed in a storyboard type or in different types. This enables the advertising screens to be displayed in various developing techniques when compared with the existing single screen or three-screens advertisement devices. Furthermore, a product sample for the advertisement can be put for display in each of the trigonal prisms, which enables the space in the interior of each trigonal prism to be efficiently used. This of course improves advertisement efficiency.

In addition, each side of the trigonal prism may be formed of a Panapress advertising plate, in which lighting equipment is disposed in the interior of the trigonal prism, which achieves a high degree of resolution in the advertising image.

What is claimed is:

1. A trigonal prism turning display device for advertisement comprising:
six trigonal prisms arranged in a shape of a regular triangle, each of said six trigonal prisms having the three sides on each of which an advertising screen is displayed;
upper and lower turning discs for supporting said six trigonal prisms and rotating together with a main shaft;
driving means mounted under said lower turning disc, for rotating said six trigonal prisms;
disc-shaped device supporting means mounted under said driving means and fixed to the inner surface of a cylindrical housing at the outer peripheral portion thereof, for supporting said main shaft and said driving means; and
a motor disposed under said disc type device supporting means in such a manner as to be connected to the lower end of said main shaft by a coupler.

2. The trigonal prism turning display device according to claim 1, wherein said main shaft is coupled to the shaft of said motor through said coupler, at the lower end thereof, is secured on the central portion of said lower turning disc, at the central portion thereof, and is secured on the central portion of said upper turning disc, at the upper end thereof, such that said upper and lower turning discs are rotated together with said main shaft that delivers the rotating force of said motor to said driving means.

3. The trigonal prism turning display device according to claim 1, wherein said cylindrical housing is made of a transparent acryl and places a fixing member that is adapted to fix said main shaft in the central portion of the upper surface thereof, said six trigonal prisms in the upper portion thereof, said driving means in the central portion thereof, and said motor in the lower portion thereof.

4. The trigonal prism turning display device according to claim 1, wherein said driving means comprises: a base gear coupled to said main shaft through a bolt that is fixedly installed on the central portion of said device supporting part; a pair of crankshaft gears engaged with said base gear at intervals of 180° in a rotating direction of said base gear; a pair of connecting rods fixedly mounted at the margins of crank connecting discs that are secured on the lower surfaces of said crankshaft gears; a pair of crankshafts connected to the frontal ends of said connecting rods; a pair of partial gears fixed on said crankshafts at the rotating central portions thereof; first and second trigonal prism power transmission gears engaged with said partial gears at the lower portion thereof so as to be rotated as said partial gears are rotated; first trigonal prism turning gears that are engaged at intervals of 120° with said first trigonal prism power transmission gear such that the three trigonal prisms of odd numbers are rotated; and second trigonal prism turning gears engaged at intervals of 120° with said second trigonal prism power transmission gear such that the other trigonal prisms of even numbers are rotated.

5. The trigonal prism turning display device according to claim 1, wherein each of said first trigonal prism turning gears is fixed with a disc-shaped connecting member at the top end of the shaft thereof and each of said disc-shaped connecting members is secured on the bottom surface of the one side of each of said three trigonal prisms of the odd numbers at the central upper surface thereof, such that said three trigonal prisms of the odd numbers are rotated as said first trigonal prism turning gears are rotated, and each of said second trigonal prism turning gears is fixed with a disc-shaped connecting member at the top end of the shaft thereof, and each of said disc-shaped connecting members is secured on the bottom surface of the one side of each of said other trigonal prisms of the even numbers on the central upper surface thereof, such that said other trigonal prisms of the even numbers are rotated as said second trigonal prism turning gears are rotated.

6. The trigonal prism turning display device according to any one of claims 1 to 5, wherein each of said six trigonal prisms is made of glass, acryl, or aluminum such that it has a hollow part in the interior thereof and has a product display stand in one side among the three sides thereof.

7. The trigonal prism turning display device according to claim 6, wherein said hollow part has lighting equipment therein.
